(19) United States
(12) Patent Application Publication
(10) Pub. No.: US 2014/0104140 A1
(43) Pub. Date: Apr. 17, 2014

(54) INFORMATION OUTPUT APPARATUS AND METHOD FOR OUTPUTTING IDENTICAL INFORMATION AS ANOTHER APPARATUS

(71) Applicant: Casio Computer Co., Ltd., Tokyo (JP)

(72) Inventors: Fuminori SANO, Tokyo (JP); Yoshihiro Sato, Saitama (JP)

(73) Assignee: CASIO COMPUTER CO., LTD., Tokyo (JP)

(21) Appl. No.: 14/037,499

(22) Filed: Sep. 26, 2013

(30) Foreign Application Priority Data
Oct. 11, 2012 (JP) 2012-226032
May 7, 2013 (JP) 2013-097394

(51) Int. Cl. G06F 3/14

(52) U.S. Cl. CPC G06F 3/1454
USPC 345/2.2

(57) ABSTRACT

An object of the present invention is that, even when the output source of information being outputted by another apparatus is unknown by a user, an apparatus can output the identical information by accessing the output source of the information without communication connection. A PC apparatus acquires and analyzes the information (image, sound) being outputted by the another information output apparatus by image capturing or sound collecting, thereby detecting the output source of the information (broadcast channel, URL, etc.) and then accesses the output source, thereby outputting the information, which is identical to the information being outputted by the another information apparatus, also by the PC apparatus.

### CROSS-REFERENCE TO RELATED APPLICATIONS

This application is based upon and claims the benefit of priority from the prior Japanese Patent Applications No. 2012-226032, filed Oct. 11, 2012 and No. 2013-097394, filed May 7, 2013, the entire contents of which are incorporated herein by reference.

### BACKGROUND OF THE INVENTION

1. Field of the Invention

The present invention relates to an information output apparatus and method for outputting information.

2. Description of the Related Art

Conventionally, as a technology which displays identical information at the same time by a plurality of terminal apparatuses, for example, a technology configured to transmit a contents ID from a first portable terminal apparatus to a second portable terminal apparatus during a call, thereby displaying the identical contents by the portable terminal apparatuses at the same time and sharing the contents with a partner of the call has been developed (Japanese Patent Application Laid-Open (Kokai) Publication No. 2004-297250). Also, a technology configured to connect a plurality of terminal apparatuses via a network, thereby synchronously displaying identical contents on screens has been developed (Japanese Patent Application Laid-Open (Kokai) Publication No. 2010-067108).

However, in each of the above-described technologies, communication connection between a plurality of terminal apparatuses and another terminal apparatus has been presumed for displaying the identical information by the plurality of terminal apparatuses at the same time. As a result, identical information cannot be displayed at the same time in the following cases, for example: the plurality of terminal apparatuses are not provided with a communication connection function; a communication method is different from that of the another terminal apparatus; or the communication environment thereof is bad.

### SUMMARY OF THE INVENTION

An object of the present invention is to access an output source of information and output identical information without communication connection even if a user does not know the output source of the information being outputted by the another apparatus.

The present invention has a below configuration. An information output apparatus for outputting information, comprising: an acquisition section which acquires information being displayed by another information output apparatus other than the information output apparatus; a detection section which analyzes the information acquired by the acquisition section and detects an output source of the information; and an output control section which carries out control for accessing the output source detected by the detection section, and outputting information identical to the information, which is being outputted by the another information output apparatus.

According to the present invention, even if the user does not know the output source of the information being outputted by another apparatus, the output source of the information can be accessed to output identical information without communication connection. Accordingly, user-friendliness is improved.

The above and further objects and novel features of the present invention will more fully appear from the following detailed description when the same is read in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a drawing showing a state where identical information is outputted to a PC apparatus 1 and another information output apparatus 2 at the same time;

FIG. 2 is a drawing for explaining a characteristic portion of an application screen;

FIG. 3 is a block diagram showing basic components of the PC apparatus 1;

FIG. 4 is a flowchart showing operations in the PC apparatus 1 side;

FIG. 5 is a flowchart to describe in detail Step A4 of FIG. 4:

FIG. 6 is a flowchart to describe in detail Step A5 of FIG. 4;

FIG. 7 is a flowchart showing operations in the PC apparatus 1 side in a second embodiment;

FIG. 8 is a flowchart to describe in detail Step A5 of FIG. 4 in a third embodiment; and

FIG. 9 is a flowchart subsequent to the operations of FIG. 8.

### DETAILED DESCRIPTION OF THE PREFERRED EMBODIMENTS

### First Embodiment

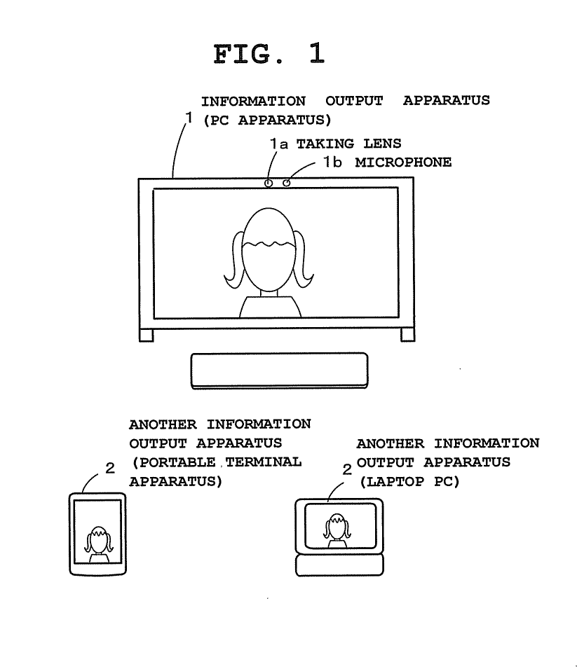

Hereinafter, a first embodiment of the present invention will be explained with reference to FIG. 1 to FIG. 6.

The present embodiment exemplifies a case of applying a personal computer (PC) apparatus 1 as an information output apparatus. FIG. 1 is a drawing showing a state where a CPU outputs identical information to the information output apparatus (PC apparatus) 1 of its own and another information output apparatus 2 at the same time.

The PC apparatus (information output apparatus) 1 is provided with a stationary-type (desktop) large screen. The PC apparatus 1 is provided with a camera function and a sound collecting function in addition to various application functions such as a text creating function, an address-book function, a mailer function, a television-broadcast receiving function, a radio-broadcast receiving function, an Internet connecting function, etc.

The camera function in the first embodiment is provided with a taking lens 1a, which is arranged at an upper-end center portion of a front surface of the PC apparatus 1. The camera function is configured to be used as an information acquiring function (image acquiring function), which captures an image of an entire display screen of the another information output apparatus 2, in the example shown in FIG. 1, a portable terminal apparatus (for example, smartphone) or a laptop PC, thereby acquiring the information of the entirety displayed in the screen (image of the entire screen).

The PC apparatus 1 is configured to acquire the captured image, which has been captured by the camera function; detect an output source of the image by analyzing the captured image; and access the output source. As a result, the PC apparatus 1 outputs, also by itself, the identical image as the image displayed by the another information output apparatus 2. In other words, the PC apparatus 1 is configured to make its own output state become the identical output state (identical environment) as the another information output apparatus 2.

Herein, “the output source of the image” means as follows: if the image displayed by the another information output apparatus 2 is an image of television broadcast, “the output source of the image” means a channel of a broadcasting station broadcasting the program thereof. In the case of an image of an application screen, “the output source of the image” means an application type (the address-book function, the mailer function, the text creating function, etc.). In the case of an image of a Web (World Wide Web) page, “the output source of the image” means the URL (Uniform Resource Locator) thereof. In the case of an image of a material commonly saved in the PC apparatus 1 and the another information output apparatus 2 (saved common material), “the output source of the image” means the path name and/or page number of the file thereof.

In this case, when the captured image is acquired by capturing by the camera function the entire image displayed on the screen of the another information output apparatus (a portable terminal apparatus, laptop PC, etc.) 2, the PC apparatus 1 is configured to analyze the captured image, thereby automatically judging the type (for example, television broadcast, an application screen, a Web page, an image of a saved common material) of the image capture target (the image displayed on the another information output apparatus 2) and then detect the output source (the broadcasting channel, URL, path name, etc.) of the image in accordance with the judged type.

The sound collecting function is provided with a microphone 1b, which is arranged at an upper-end center portion of the front surface of the PC apparatus 1, and collects the surrounding sounds. Details thereof will be explained in a second embodiment, which will be described further below.

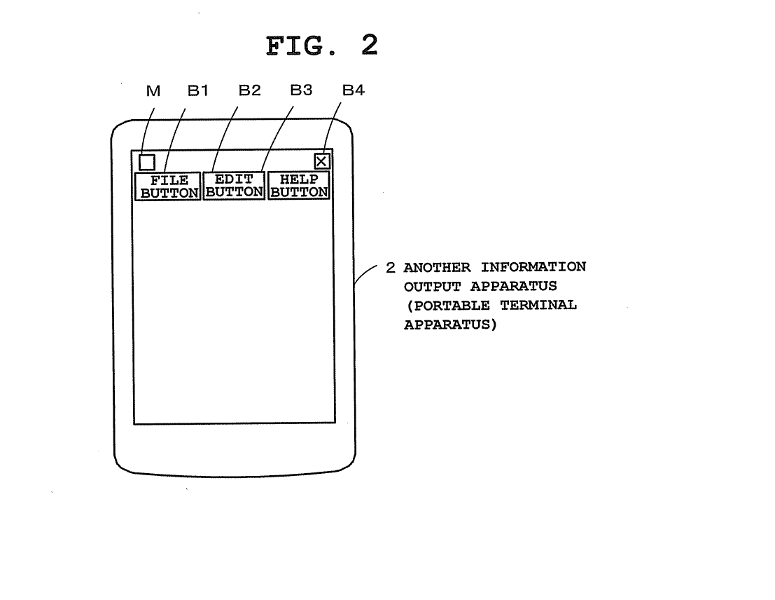

FIG. 2 is a drawing for explaining a characteristic portion of an application screen serving as a criterion for automatically judging the type of the image capture target in the case where the image capture target is the application screen. FIG. 2 shows a case where the application screen is displayed on the another information output apparatus (portable terminal apparatus) 2.

Generally, in a header portion or a footer portion of an application screen, an application-symbolized mark(s) (symbol(s)) and/or a character string(s) such as an application name, various numbers, and various buttons and/or icons serving as referential indexes are arranged and displayed as the marks, characters, and numbers unique to the application thereof. Therefore, when the PC apparatus 1 captures the image of the application screen displayed on the another information output apparatus (portable terminal apparatus) 2 and analyzes the captured image, the PC apparatus 1 is configured to judge that the image capture target is an application screen by recognizing the unique mark(s), character(s), and/or number(s).

The example shown in FIG. 2 shows the application screen in which a file button B1, an edit button B2, a help button B3, a close button B4, etc. are arranged as referential indexes (buttons or icons) other than a symbol M.

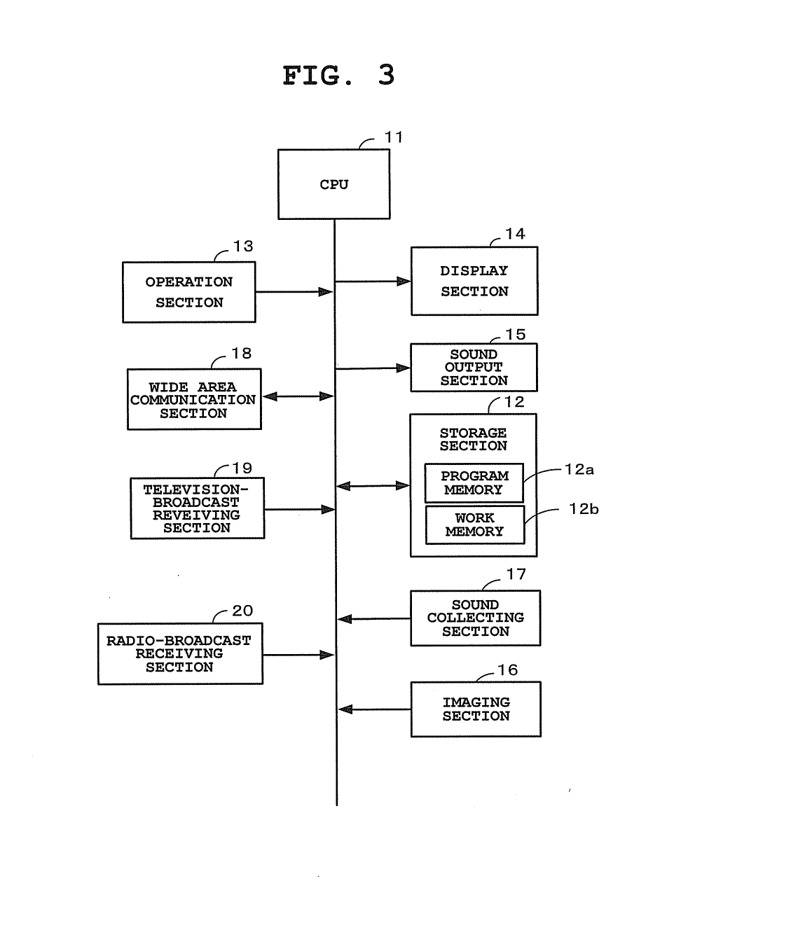

FIG. 3 is a block diagram showing basic components of the PC apparatus 1.

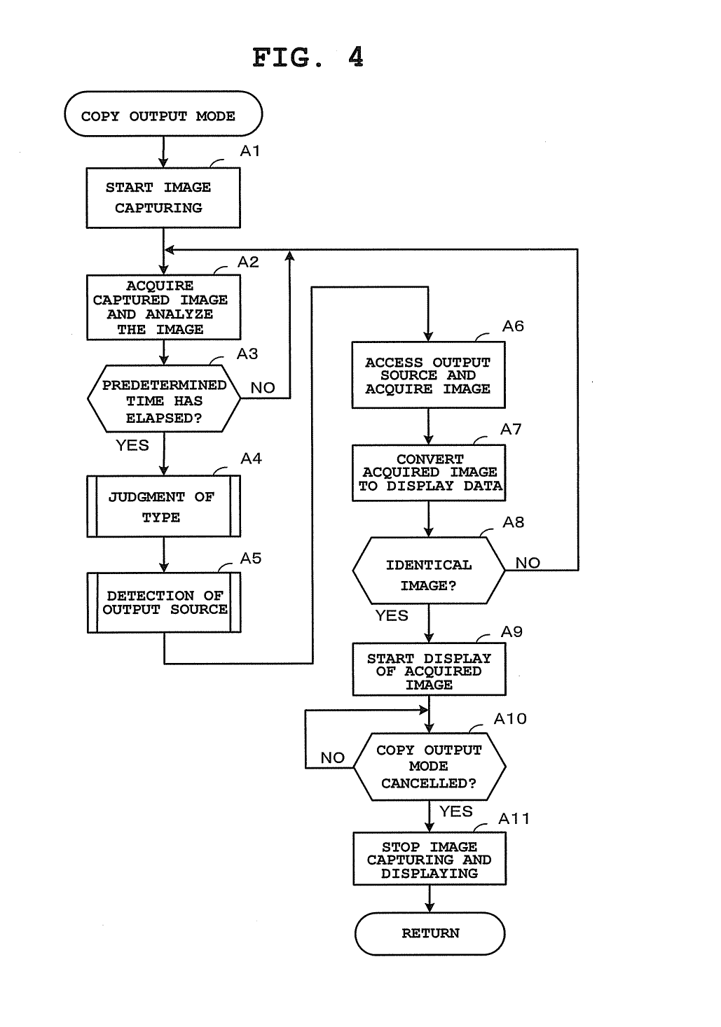

The CPU 11 is a central processing unit which operates by receiving power from a power supply from a power supply section (not shown) and controls the entire operation of the PC apparatus 1 in accordance with various programs in a storage section 12. The storage section 12 is configured to have, for example, a ROM (Read-Only Memory) and a flash memory, and includes a program memory 12a, having stored therein programs and various applications for achieving the present embodiment according to an operation procedure depicted in FIG. 4 to FIG. 6, which will be described further below, and a work memory 12b which temporarily stores various information (for example, a flag) required for the operation of the PC apparatus 1.

The storage section 12 may be configured to include a removable portable memory (recording medium) such as an SD (Secure Digital) card and/or an IC (Integrated Circuit) card, or may be configured to include, although not shown, a storage area of a predetermined server apparatus side in a case where the PC apparatus 1 is connected to a network via a communication function.

An operation section 13 includes a mode switch key(s) in addition to various push-button-type keys such as character keys and a numeric keypad although not shown. The CPU 11 carries out processing according to input operation signals outputted from the operation section 13 in response to the operation keys. The mode switch key is a key which carries out switching to an operation mode desired by a user among various operation modes, and an example thereof carries out switching to a copy output mode. The copy output mode is an operation mode in which the CPU 11 accesses the output source of the information, which is outputted to the another information output apparatus 2, and outputs the identical information at the same time.

As output forms in the copy output mode, a display output is exemplified in the first embodiment, and a sound output is exemplified in the second embodiment, which will be described further below.

A display section 14 is, for example, a high-definition liquid crystal display or an organic EL (Electro Luminescence) display having a screen where the aspect ratio differs (for example, 4:3 [width to height]). A sound output section 15 is provided with stereo speakers (not shown), etc. and outputs sounds of television broadcast, radio broadcast, etc. An imaging section 16 constitutes the above described camera function constitutes a camera section capable of imaging a subject with high definition by forming a subject image from the taking lens 1a onto an imaging element (such as a CCD (Charge-Coupled Device) or a CMOS (Complementary Metal-Oxide Semiconductor)). This imaging section 16, which is capable of capturing still images and moving images, performs color separation, gain adjustment for each RGB (Red Green Blue) color component, and the like on photoelectrically converted image signals (analog value signals), and after converting the image signals to digital value data, performs color interpolation processing (de-mosaic processing) on the digitalized image data, and displays the image data in full-color on display section 14.

Moreover, in the present embodiment, the imaging section 16 is also capable of performing a zoom function, Auto Focus processing (AF processing), Auto Exposure adjustment processing (AE processing), Auto White Balance adjustment processing (AWB processing), etc. A sound collecting section 17 is provided with the microphone 1b and constitutes the above-described sound collecting function.

A wide area communication section 18 is connected (to broadband Internet (such as by optical communication connection). When a Web page on the Internet is accessed as a result of start-up of a Web browser, the Web page can be viewed or webcasting can be viewed/listened to.

A television-broadcast receiving section 19 is capable of receiving terrestrial digital television broadcasts for communication terminal devices, as well as program information such as Electronic Program Guides (EPG). The television-broadcast receiving section 19 extracts broadcast signals of a channel, which has been selected in advance from among television broadcast signals, separates the broadcast signals into images (video), sounds, and data (character data) to decode the signals. Television broadcast can be viewed/listened to as a result of start-up of the television-broadcast receiving section 19. A radio-broadcast receiving section 20 receives radio broadcast waves of AM/FM broadcast, etc. and outputs digital sound signals. As a result of start-up of the radio-broadcast receiving section 20, radio broadcast can be listened to.

Next, the operation concept of the PC apparatus 1 in the present embodiment is described with reference to the flowcharts shown in FIG. 4 to FIG. 6. Here, each function described in the flowcharts is stored in a readable program code format, and operations based on these program codes are sequentially performed. Also, operations based on the above-described program codes transmitted over a transmission medium such as a network can also be sequentially performed.

That is, the unique operations of the present embodiment can be performed using programs and data supplied from an outside source over a transmission medium, in addition to a recording medium. FIG. 4 to FIG. 6 are the flowcharts outlining the operation of the characteristic portion of the present embodiment from among all of the operations of the PC apparatus 1. When the CPU 11 exits the flows of FIG. 4 to FIG. 6, the CPU 11 returns to a main flow (not shown) of the entire operations.

FIG. 4 is a flowchart showing operations of the PC apparatus 1 side which are started when the CPU 11 switches to the copy output mode in which the identical information is displayed at the same time by accessing the output source of the information displayed on the another information apparatus 2. When the user switches the mode to the copy output mode by operating the above-described mode switch key in a state where the another information output apparatus 2 is displaying a desired image and that the screen of the another information output apparatus 2 is directed toward the PC apparatus 1 side, the flow of FIG. 4 is started.

First, when the mode is switched to the copy output mode by the user operation, the CPU 11 of the PC apparatus 1 starts up the imaging section 16 to start image capturing (Step A1). In this case, the image displayed on the entire screen of the another information output apparatus 2 is captured by the imaging section 16 of the PC apparatus 1.

Then, the CPU 11 checks whether predetermined time has elapsed after start of the image capturing (Step A3) while acquiring the captured image and carrying out image analysis (Step A2). Herein, the predetermined time is the time required for judging, for example, whether the image is a still image or a moving image by the analysis of the captured image, and the CPU 11 returns to the above-described Step A2 until the predetermined time elapses. If elapse of the predetermined time is detected at this point (YES in Step A3), the CPU 11 carries out a type judging processing (Step A4) of judging the type of the image capture target (copy type) and then proceeds to a processing of detecting the output source of the image in accordance with the judged type (Step A5).

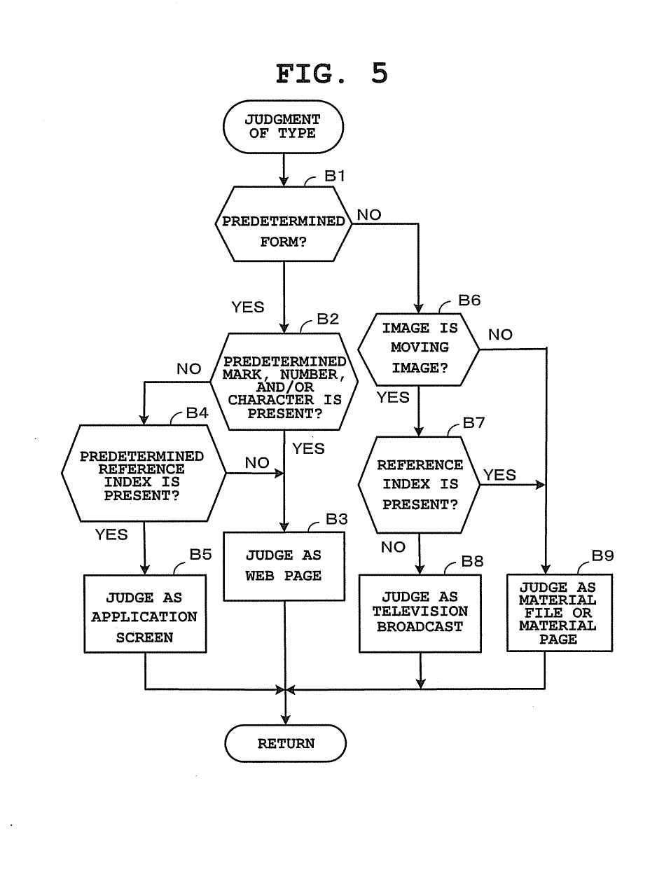

FIG. 5 is a flowchart to describe in detail the type judging processing (Step A4 of FIG. 4) of judging the type of the image capture target (copy type).

First, in the PC apparatus 1, the CPU 11 thereof checks whether or not the image meets a predetermined form based on the result of the analysis of the captured image (Step B1). For example, the CPU 11 checks whether or not at least a header portion or a footer portion in the image meets a predetermined form by carrying out pattern matching of comparison with a reference form prepared in advance. If the image meets a predetermined form (YES in Step B1), the CPU 11 checks whether the image contains a predetermined mark(s), number(s) and/or character(s) in the header portion or the footer portion, (Step B2).

For example, if a character(s) is present in the header portion or the footer portion, the CPU 11 checks, for example, whether or not any of “PFile”, “Favorites”, “Tools”, and “Help” unique to a Web page is present. If the predetermined mark(s), number(s), and/or character(s) is present (YES in Step B2), the CPU 11 judges that the image capture target is an image of a Web page (Step B3).

If the predetermined mark(s), number(s), and/or character(s) is not present in the header portion or the footer portion (NO in Step B2), the CPU 11 checks whether or not the image contains a predetermined referential index(es) (icon(s) and/or button(s)) therein (Step B4). In this case, according to the shape(s) of the mark(s), character(s), etc. constituting the referential index(es), the CPU 11 checks whether the image contains an icon(s) and/or button(s) unique to an application and capable of using as a predetermined referential index(es) (for example, the File button B1, the Edit button B2, etc. shown in FIG. 2). If the predetermined referential index(es) is contained (YES in Step B4), the CPU 11 judges that the image capture target is an image of an application screen (Step B5). If the predetermined index(es) is not contained (NO in Step B4), the CPU 11 judges that the image capture target is an image of a Web page (Step B3).

On the other hand, if the header portion or the footer portion does not meet the predetermined form, the CPU 11 judges that there is no predetermined form in the image (NO in Step B1). Then, the CPU 11 checks whether or not the captured image is a moving image (Step B6). If the image is a moving image (YES in Step B6), the CPU 11 checks whether the image contains a referential index(es) (icon(s) and/or button(s)) (Step B7).

If the image does not contains the referential index(es) at this point (NO in Step B7), the CPU 11 judges that the image capture target is an image of television broadcast (Step B8).

If the image is not a moving image (NO in Step B6), the CPU 11 judges that the image capture target is an image of a saved common material (Step B9). Even if the image is a moving image (YES in Step B6), when the image contains an index(es) (YES in Step B7), the CPU 11 judges that the image capture target is an image of a saved common material (Step B9).

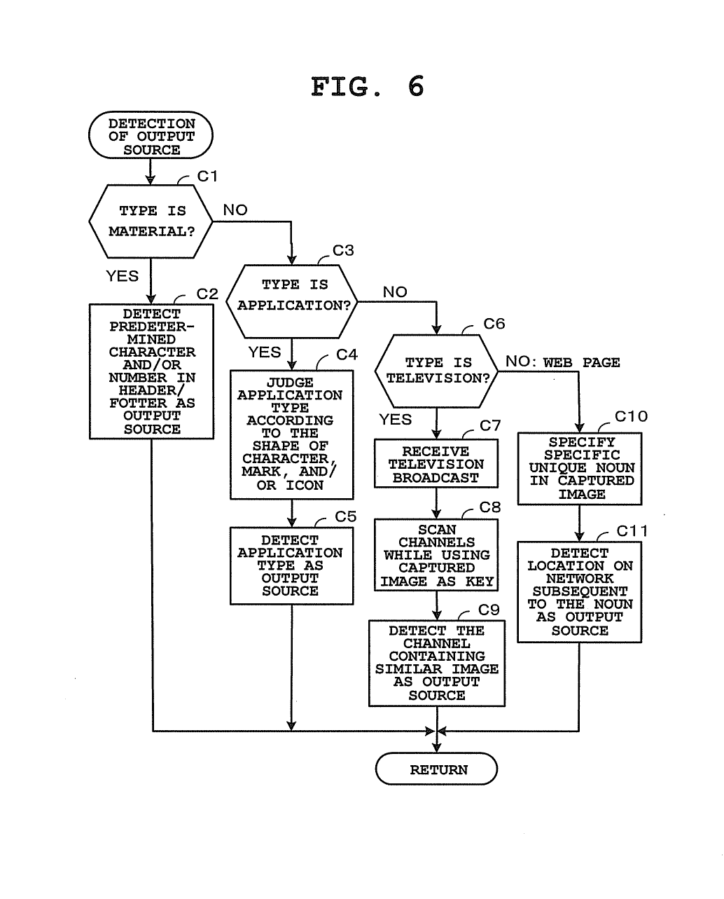

FIG. 6 is a flowchart to describe in detail an output-source detecting processing (Step A5 of FIG. 4) of detecting the output source of the image in accordance with the type of the image capture target.

First, the CPU 11 checks whether the type judged in the above-described type judging processing (Step A4 of FIG. 4) is the image of a saved common material or not (Step C1), checks whether the type is the image of an application screen (Step C3), and/or checks whether the type is the image of television broadcast or not (Step C6). If the type of the image capture target is the image of a saved common material at this point (YES in Step C1), the CPU 11 detects the output source (for example, a path name, page number) based on the character(s), number(s), and/or mark(s) in the header portion or the footer portion in the captured image (Step C2).

If the type of the image capture target is the image of an application screen (YES in Step C3), the CPU 11 judges the application type according to the shape(s) of the character(s), mark(s), and icon(s) in the header portion or the footer portion in the captured image (Step C4) and detects the application type as the output source (address book, mailer, text creation, etc.) of the image (Step C5).

If the type is the image of television broadcast (YES in Step C6), the CPU 11 turns on the television-broadcast receiving section 19 to start reception of television broadcast (Step C7), sequentially scans (select) the broadcasted programs of channels while using the captured image (television broadcast image) as a key (Step C8), and detects the channel, which contains an image(s) similar to the key, as the output source (Step C9). In this case, after the decoding the images from the broadcast signals of the sequentially selected channels and converting the images to display data, the CPU 11 judges whether or not the respective channel is the channel including an image similar to the key.

This processing is not limited to the case of comparing the entirety of the images, and the comparison may be carried out by focusing on part of the image (for example, end portion, center portion). Also, it is not limited to perfect matching, and approximate matching may be applied.

If the type of the image capture target is not the image of television broadcast, (NO in Step C6), the CPU 11 judges that the type is the image of a Web page and proceeds to Step C10. The CPU 11 specifies a specific unique noun constituting a URL in the captured image (Step C10) and detects a location on a network subsequent the specific unique noun (Step C11). For example, if connection to a Web server is made by using a HTTP protocol, the CPU 11 specifies “http://” as a specific unique noun which constitutes a URL and detects a location on a network subsequent to the above-described “http://” as the output source. If connection to a FTP server is made by using a FTP protocol, the CPU 11 specifies “ftp://” as a specific unique noun which constitutes a URL and detect the location on a network subsequent to the above-described “ftp://” as the output source.

When the output-source detecting processing (Step A5 of FIG. 4) as described above is finished, the CPU 11 accesses the output source to acquire an image(s) (Step A6) and converts the image to display data (Step A7). For example, if the type of the captured image is a saved common material, the CPU 11 accesses a material file or a material page in the storage section 12 based on the output source (path name, page number), acquires the material file or material page thereof, and coverts that to the display data thereof.

If the type of the image capture target is the image of an application screen, the CPU 11 accesses the output source thereof (address book, mailer, text creation, etc.) and converts the image information thereof to the application screen. If the type is the image of television broadcast, the CPU 11 accesses the output source (channel) and converts that to television broadcast images thereof. If the type is the image of a Web page, the CPU 11 accesses the output source (URL) thereof and converts that to a page image thereof.

Thus, the CPU 11 compares the acquired image acquired and converted from the output source with the captured image, thereby checking whether they are the identical images (Step A8). This processing is not limited to the case where the CPU 11 checks if they are the identical images by comparing the entirety of the images, but the CPU 11 may be configured to check whether they are the identical images by comparing part of the images (for example, end portion, center portion). Also, it is not limited to perfect matching, and the CPU 11 may be configured to judge that they are the identical images with approximate matching.

At this point, if the images are not identical images (NO in Step A8), the CPU 11 returns to above-described Step A2 in order to start over the processing from the beginning. However, if the images are identical images (YES in Step A8), the CPU 11 starts an operation of displaying the image, which has been acquired from the output source, by the display section 14 (Step A9). In this state, the CPU 11 checks whether the copy output mode has been cancelled or not (Step A10) and continues the image displaying operation until the copy output mode is cancelled. When the copy output mode is cancelled and switched to another mode (YES in Step A10), the CPU 11 stops the image capturing operation and a displaying operation (Step A11) and then exits the flow of FIG. 4.

As described above, the PC apparatus 1 in the first embodiment is configured to acquire and analyze the information being outputted by the another information output apparatus 2, thereby detecting the output source of the information and accesses the output source. As a result, the PC apparatus 1 outputs the identical information as the information being outputted by the another information apparatus 2. Accordingly, even if the user does not know the output source of the information being outputted by the another output apparatus 2, the PC apparatus 1 is capable of accessing the output source of the information without communication connection, outputting the identical information by itself, and the PC apparatus 1 is configured to make its own output state become the identical output state (identical environment) as the another information output apparatus 2.

As a result, the image identical to an image of television broadcast, a Web page, etc. being displayed by, for example, a portable terminal apparatus or a laptop PC can be immediately displayed by a large screen of the display section 14 of the PC apparatus 1 without carrying out a special operation. Accordingly, user-friendliness is improved.

The PC apparatus 1 is configured to capture by the imaging section 16 the image being displayed by the another information output apparatus 2, and acquire and analyze the captured image, thereby detecting the output source of the image. Accordingly, the output source can be easily detected only by capturing the image, which is being outputted by the another information output apparatus 2, by the imaging section 16. In this case, even if the PC apparatus 1 and the another information output apparatus 2 are greatly far from each other in terms of distance (even if they are not brought close to each other), the image of the screen can be captured well by capturing the image by adjusting optical zoom, when the screen of the another information output apparatus 2 is to be captured. As a result, no trouble occurs in detection of the output source.

The PC apparatus 1 is configured to capture an Internet image being displayed by the another information apparatus 2 and detect, as the output source, the location thereof on the network subsequent to the specific unique noun in the character string contained in the image. Accordingly, only by capturing the Internet image, the PC apparatus 1 can connect to the Internet and display the image thereof.

The PC apparatus 1 is configured to capture the image of the television broadcast being displayed by the another information apparatus 2 and detect the channel containing similar images as the output source of the image by scanning the channels of television broadcast while using the image as a key. Therefore, the television broadcast of the identical channel can be outputted only by capturing the image of the television broadcast.

The PC apparatus 1 is configured to capture the application screen being displayed by the another information output apparatus 2, and judge the application type according to the contents of the header portion in the application screen thereof, thereby detecting the application type as the output source of the screen. Accordingly, the PC apparatus 1 can connect to the application and display the application screen only by capturing the image of the application screen.

The PC apparatus 1 is configured to capture the material screen being displayed by the another information apparatus 2 and detect, as the output source of the image, the specifying information specifying the material file or the specifying information specifying the page in the material file, according to the contents of the header portion or the footer portion in the material screen. Accordingly, the material file or the material page can be displayed only by capturing the image of the material screen.

The PC apparatus 1 is configured to detect the output source of the information in accordance with the type after analyzing the captured image and judging the type of the captured image. Accordingly, the output source can be detected after narrowing down the image capture target, and the detection becomes more reliable.

The PC apparatus 1 is configured to judge the type of the image capture target based on whether the captured image has a portion therein, including a header portion or a footer portion, which meets a predetermined form; whether the captured image contains the predetermined character(s) or number(s) in the portion of the image that meets the predetermined form (e.g. a header portion or a footer portion); whether the captured image contains the predetermined referential index(es); and whether the captured image is a still image or a moving image. Accordingly, the captured image can be appropriately sorted.

The PC apparatus 1 is configured to judge whether the image acquired by accessing the detected output source and the captured image are identical to each other or not; if they are not the identical images, repeat the operation of detecting the output source of the image by further acquiring and analyzing the captured image; and, if they are the identical images, output the image from the output source. Accordingly, even if accuracy of detecting the output source is not high, the accuracy can be compensated for.

In the above-described first embodiment, the image of television broadcast, the image of an application screen, the image of a Web page, and the image of a saved common material are shown as image capture targets (images). However, the image capture targets are not limited thereto, but may be, for example, a projected image of a projector.

In the above-described first embodiment, as shown in FIG. 5, the type of the image capture target is configured to be judged based on whether the captured image has a portion, including a header portion or a footer portion, which meets a predetermined form; whether the captured image contains the predetermined character(s) or number(s) in the portion of the image (e.g. the header portion or the footer portion) that meets the predetermined form; whether the captured image contains the predetermined referential index(es), and whether the captured image is a still image or a moving image. However, the judgment is not limited thereto, but the type of the image capture target may be configured to be judged based on, for example, whether the footer portion contains a page number or whether a center portion of the image contains a character string (material name) having a predetermined size or more.

In the above-described first embodiment, the type of the image capture target is configured to be automatically judged. However, an arbitrary type may be configured to be specified by user operation, or both of the automatic judgment of the type and the user specification may be enabled.

### Second Embodiment

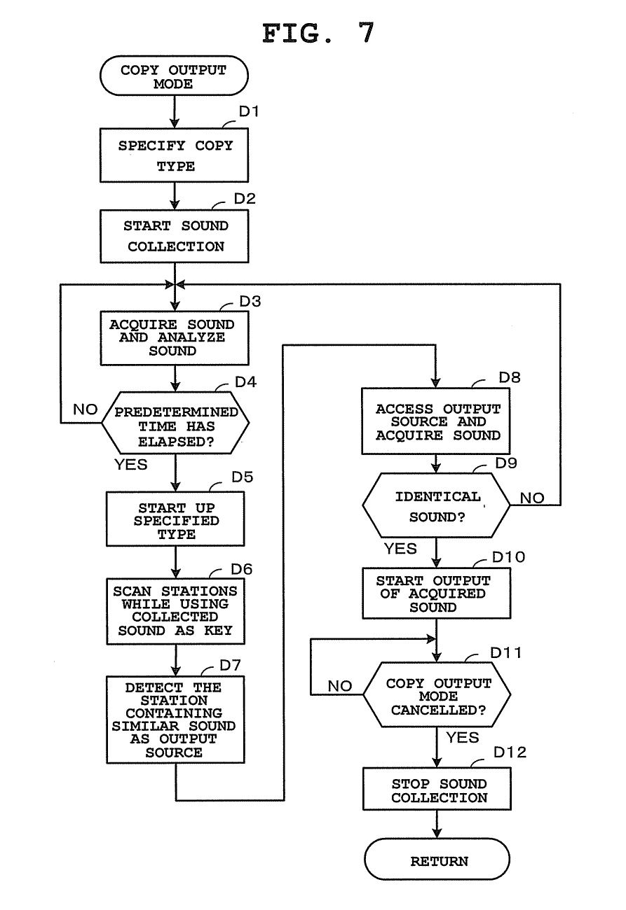

Hereinafter, the second embodiment of the present invention will be explained with reference to FIG. 7.

In the above-described first embodiment, the PC apparatus 1 is configured to capture the image, which is being displayed by the another information output apparatus 2, by the imaging section 16, and acquire and analyze the captured image, thereby detecting the output source of the image. However, in the second embodiment, the PC apparatus 1 is configured to collect the sound being outputted by the another information apparatus 2 by the sound collecting section 17 and carry out sound analysis, thereby detecting an output source of the sound. Thus, they are different from each other in the point that the output source is detected from image analysis or the output source is detected from sound analysis. Note that sections that are basically or nominally the same in both embodiments are given the same reference numerals, and explanations thereof are omitted. Hereinafter, a characteristic portion of the second embodiment will be mainly explained.

The above-described sound collecting function is an information acquiring function for collecting and acquiring the sound being outputted from the another output apparatus 2. The PC apparatus 1 is configured to analyze the sound, which has been collected and acquired by the sound collecting function, thereby detecting the output source of the sound and access the output source, thereby outputting the sound, which is identical to the sound being outputted from the another information output apparatus 2, by itself.

Herein, “the output source of the sound” means as follows: if the sound being outputted from the another information apparatus 2 is radio broadcast, “the output source of the sound” means a broadcasting station (frequency) broadcasting the program thereof. In a case of television broadcast, “the output source of the sound” means a broadcasting station (channel) broadcasting the program thereof. In a case of webcasting (for example, Internet casting), “the output source of the sound” means a relay station (Internet address).

In the above-described first embodiment, the type (copy type) of the image capture target is configured to be automatically judged. However, in the second embodiment, the type of the sound collecting target can be arbitrarily specified by user operation.

FIG. 7 is a flowchart showing operations of the PC apparatus 1 which are started when the mode is switched to the copy output mode in the second embodiment. In a state where desired sound is outputted by the another information output apparatus 2, the user switches the mode to the copy output mode by operating the mode switch key.

First, when any of radio broadcast, television broadcast, and webcasting is arbitrarily specified as the type (copy type) of a sound collection target by user operation (Step D1), the CPU 11 of the PC apparatus 1 starts a sound collecting operation of recording the sound from the sound collecting section 17 (Step D2) and checks whether predetermined time has elapsed after starting the sound collection (Step D4) while analyzing the sound (Step D3).

Herein, the predetermined time is the time required for judging a characteristic of the sound by the sound analysis. The CPU 11 returns to above-described Step D3 until the predetermined time elapses. When the predetermined time elapses (YES in Step D4), in accordance with the type (copy type) specified by the user in advance, the CPU 11 starts up any of the wide area communication section 18, the television-broadcast receiving section 19, and the radio-broadcast receiving section 20 corresponding to the type (Step D5).

Then, the CPU 11 starts receiving webcasting, television broadcast, or radio broadcast from the started wide area communication section 18, the television-broadcast receiving section 19, or the radio-broadcast receiving section 20. In this processing, the CPU 11 sequentially scans (selects) stations (TV stations, radio stations, or relay stations) while using the collected sound as a key (Step D6) and detects the station, which contains similar sound, as the output source (Step D7). The CPU 11 accesses the output source detected as a result of this processing, thereby receiving and acquiring the sound of the webcasting, television broadcast, or radio broadcast (Step D8) and checks whether or not the sound is the sound identical to the collected sound (Step D9).

Steps D7 and D9 are not limited to the case where the entirety of the sounds are compared with each other. The comparison may be carried out by focusing on the sound of a predetermined frequency. Also, it is not limited to perfect matching, and approximate matching may be applied.

If the sound is not identical to the collected sound (NO in Step D9), the CPU 11 returns to above-described Step D3 in order to start over the processing from beginning. However, if the sounds are identical to each other (YES in Step D9), the CPU 11 starts an operation of outputting the sound, which is acquired from the output source, from the sound output section 15 (Step D10). In this state, the CPU 11 checks whether the copy output mode has been cancelled or not (Step D11) and continues the sound outputting operation until the copy output mode is cancelled. When the copy output mode is cancelled and switched to another mode (YES in Step D11), the CPU 11 stops the sound collecting operation and the sound outputting operation (Step D12) and then exits the flow of FIG. 7.

As described above, in the second embodiment, the PC apparatus 1 is configured to collect and analyze the sound, which is being outputted by the another information output apparatus 2, by the sound collecting section 17, thereby detecting the output source of the sound. Therefore, even if the user does not know the output source of the sound being outputted from the another information apparatus 2, the identical sound can be outputted by accessing the output source of the sound without communication connection. Accordingly, user-friendliness is improved.

The PC apparatus 1 is configured to scan the stations while using the collected sound as a key, thereby detecting the station containing a similar sound as the output source of the sound. Accordingly, the sound of the identical station can be outputted only by collecting the sound of the television broadcast, radio broadcast, or webcasting.

The type of the sound collection target can be arbitrarily specified by user operation. Accordingly, this is effective, for example, when the number of the types is large.

The PC apparatus 1 is configured to judge whether the sound, which has been acquired by accessing the detected output source, and the collected sound are identical to each other or not; if they are not the identical sounds, further collect and analyze a sound, thereby repeating the operation of detecting the output source of the sound; and, if they are identical sounds, output the sound from the output source. Therefore, even if accuracy of detecting the output source is not high, the accuracy can be compensated for.

In the above-described second embodiment, the type of the sound collection target can be arbitrarily specified by user operation. However, the type of the sound collection target may be configured to be automatically judged by scanning the stations while using the collected sound as a key, thereby detecting the station containing a similar sound as the output source of the sound.

In this case, the type of the sound collection target can be automatically judged if the PC apparatus 1 is configured as the following example: the CPU 11 of the PC apparatus 1 the starts up the television-broadcast receiving section 19 and scan stations; if any station containing a similar sound is not found, then the CPU 11 starts up the radio-broadcast receiving section 20 and scan stations; and, if any station containing a similar sound is not found, the CPU 11 further starts up the wide area communication section 18 and scan stations. In the above-described example, the television-broadcast receiving section 19, the radio-broadcast receiving section 20, and the wide area communication section 18 are configured to be started up in this order. However, as a matter of course, the order is not limited thereto, but is arbitrary.

In the above-described embodiments, the PC apparatus 1 is configured to acquire and analyze the information being outputted to the another information output apparatus 2, thereby detecting the output source of the information; judge whether the information acquired by accessing the output source and the information being outputted to the another information apparatus 2 are identical to each other or not; if the information is not identical, repeat the operation of further acquiring and analyzing information from the another information output apparatus 2. However, the configuration of the PC apparatus 1 is not limited thereto, but the following configuration may be applied.

That is, if a plurality of output sources are detected as a result of acquiring and analyzing the information being outputted to the another information output apparatus 2, the PC apparatus 1 may be configured to sequentially judge whether the information, which has been obtained by sequentially accessing the plurality of output sources as options, and the information being outputted to the another information output apparatus 2 are identical to each other or not; if the information is identical, determine the option as the output source, acquire information from the determined output source, and output the information. As a result, even if a plurality of output sources are detected, the correct output source can be determined from among them.

In the above-described first and second embodiments, the PC apparatus 1 is configured to be separated into the case where the output source of the image is detected by image analysis and the case where the output source of the sound is detected by sound analysis. However, if the output sources of the image and the sound are identical, the PC apparatus 1 may be configured to detect the output source by either one of image analysis and sound analysis. Also, if the output source cannot be detected by image analysis, the PC apparatus 1 may be configured to detect the output source by sound analysis. Reversely, if the output source cannot be detected by sound analysis, the PC apparatus 1 may be configured to detect the output source by image analysis.

### Third Embodiment

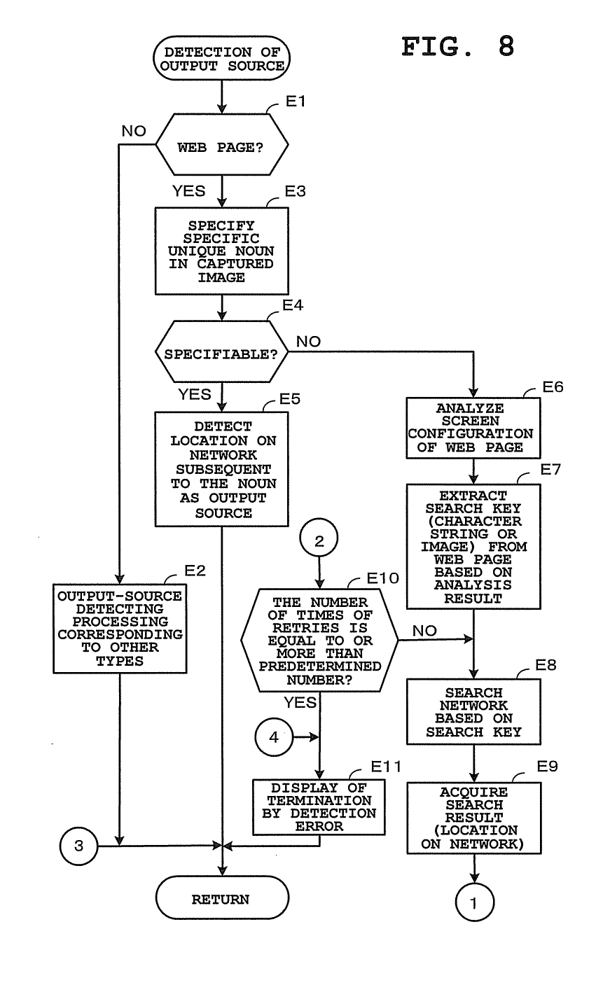

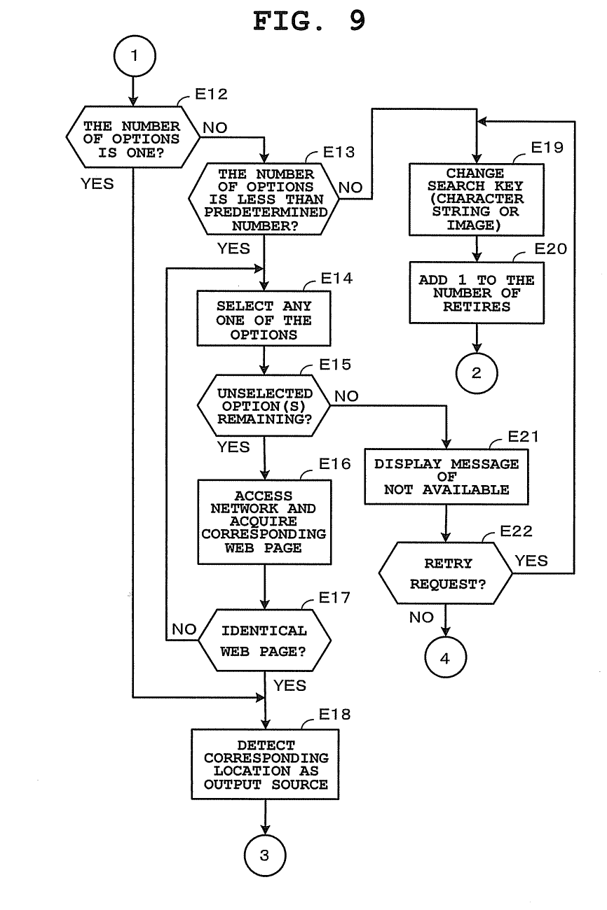

Hereinafter, a third embodiment of the present invention will be explained with reference to FIG. 8 and FIG. 9.

In the above-described first embodiment, if the type of the image capture target is judged to be an image of a Web page in the output-source detecting processing of FIG. 6 (NO in Step C6), the PC apparatus 1 is configured to detect, as an output source, the location on the network subsequent to the specific unique noun “http://” constituting the URL (Uniform Resource Locator) contained in the image by analyzing the captured image (Step C11). The third embodiment is not limited to the case where a URL is detected as an output source; and, if the captured image does not contain a URL, the PC apparatus 1 is configured to detect the output source of the image by carrying out search on a communication network (Internet) while using a keyword or a key image, which is contained in the image, as a search target.

Note that sections that are basically or nominally the same in the first and third embodiments are given the same reference numerals, and explanations thereof are omitted. Hereinafter, a characteristic portion of the third embodiment will be mainly explained.

FIG. 8 and FIG. 9 are flowcharts to describe in detail an output-source detecting processing (Step A5 of FIG. 4) of detecting an output source of an image in the third embodiment.

First, the CPU 11 checks whether the type, which has been judged in the above-described type judging processing (Step A4 of FIG. 4), is an image of a Web page or not (Step E1 of FIG. 8). If the type is a different type (NO in Step E1), in other words, if the type is any of an image of a saved common material, an image of an application screen, and an image of television broadcast, the CPU 11 proceeds to Step E2, carries out an output-source detecting processing corresponding to the type, and then the flows of FIG. 8 and FIG. 9 are completed. Note that the output-source detecting processing (Step E2) is the processing shown by Steps C1 to C9 of FIG. 6 described above.

If the judged type is an image of a Web page (YES in Step E1), the CPU 11 analyzes the captured image, thereby carrying out a processing of specifying a specific unique noun, which constitutes a URL in the image, such as “http://” in a case where connection to a Web server is made by using a HTTP protocol (Step E3). The CPU 11 checks whether above mentioned “http://” has been specified or not (Step E4). If it has been specified (YES in Step E4), the CPU 11 specifies the location thereof on a network subsequent to above mentioned “http://” as the output source (Step E5).

Also in this case, if connection to a FTP server is made by using a FTP protocol, the CPU 11 can specify “ftp://” as the specific unique noun constituting the URL and detect the location on a communication network subsequent to above mentioned “ftp://” as the output source.

If the specific unique noun “http://” constituting the URL cannot be specified (NO in Step E4), the CPU 11 proceeds to a processing of analyzing the screen configuration of the Web page (Step E6). In this case, the CPU 11 analyzes the entire screen of the Web page, thereby analyzing whether the image has a portion, including a header portion or a footer portion, which meets a predetermined form; whether the image contains a predetermined character(s) or number(s) in the portion of the image (e.g. a header portion or a footer portion) that meets the predetermined form; whether the image contains a predetermined referential index(es), etc.

The CPU 11 analyzes the screen configuration such as a window title, a tab title(s), a site banner(s), site navigation, contents navigation, main contents or advertisements in the Web page. Then, based on the result of the analysis, the CPU 11 extracts all or part of a character string(s) or image part of the title, etc. as a key (keyword or key image) of a search target (Step E7).

Then, the CPU 11 carries out search on the communication network based on the key of the search target (search key: keyword or key image) (Step E8), acquires a search result(s) (URL(s)) thereof as an option(s) of the output source (Step E9), and then proceeds to the flow of FIG. 9. First, the CPU 11 checks if the number of the search result(s) (URL(s)) or the option(s) is one (Step E12). If the number of the option is one (YES in Step E12), the CPU 11 carries out a processing of detecting (determining) the option (URL) as the output source of the image (Step E18) and then the flows of FIG. 8 and FIG. 9 are completed.

If the number of the option(s) is not one (NO in Step E12), the CPU 11 checks whether the number of the options is less than a predetermined number (for example, less than 100) or not (Step E13). If the number of the options is less than the predetermined number (YES in Step E13), the CPU 11 selects any one of them (Step E14) and checks whether an unselected option(s) is remaining, in other words, whether all of the options have been selected (Step E15).

In above-described Steps E13 and E14, if the number of the options is less than the predetermined number as a result of checking whether the number of the options is less than the predetermined number or not, the CPU 11 is configured to select any one of them. However, the CPU 11 may be configured to extract the top options corresponding to the predetermined number (for example, top 100 options) and then select one therefrom.

First, since this is a case where one of the plurality of options is selected, an unselected option(s) is remaining (YES in Step E15). Thus, the CPU 11 acquires a corresponding Web page by carrying out search on the communication network based on the selected option (URL) (Step E16). Then, the CPU 11 compares the contents of the acquired Web page and the contents of the Web page being displayed with each other to check whether they are identical (perfect matching or approximate matching) Web page or not (Step E17). If they are different from each other (NO in Step E17), the CPU 11 returns to above-described Step E14, selects another option (Step E14), and then repeats the above-described operations (Step E15 to E17).

If the identical Web page can be specified as a result of this (Step E17), the CPU 11 carries out a processing of detecting (determining) the option (URL) as the output source of the image (Step E18) and then the flows of FIG. 8 and FIG. 9 are completed.

On the other hand, if the identical Web page cannot be specified even when all the options have been selected (NO in Step E15), a message of not available indicating that no corresponding Web page has been searched is displayed in an overlapping manner in the screen (for example, pop-up display) (Step E21). At this point, the CPU 11 checks whether or not a follow-up search request has been received (retry request) by user operation (Step E22). If the retry request has not been received (NO in Step E22), the CPU 11 proceeds to Step E11 of FIG. 8, carries out display of termination by detection error, and the flows of FIG. 8 and FIG. 9 are completed.

If the retry request has been received from the user (YES in Step E22) or if the number of options is a predetermined number or more (for example, 100 or more) (YES in Step E13), the CPU 11 proceeds to Step E19 and carries out a processing of changing the search key (keyword or key image). For example, the CPU 11 changes the search key as follows: the CPU 11 changes from part of the character string of the title name, etc. to all thereof; employs character strings of a plurality of title names, etc. as keywords; or mixes the keyword with the image key. Then, the CPU 11 carries out a processing of adding “1” to the number of retries (Step E20), then proceeds to Step E10 of FIG. 8, and checks whether the number of retries is equal to or more than a predetermined number (for example, equal to or more than 4).

If the number of retries is less than the predetermined number (NO in Step E10), the CPU 11 carries out search on the communication network based on the changed search key (keyword or key image) again (Step E8) and acquires the search result(s) (URLs) thereof as an option(s) of the output source (Step E9). Thereafter, the CPU 11 proceeds to the flow of FIG. 9 and carries out a processing similar to that described above. In this case, if the CPU 11 cannot detect the output source even by repeating similar processing several times, in other words, if the number of retries is equal to or more than the predetermined number (YES in Step E10), the CPU 11 carries out display of termination by error and the flows of FIG. 8 and FIG. 9 are completed.

As described above, the PC apparatus 1 in the third embodiment is configured to capture an image of the Web page being displayed by the another information output apparatus 2, analyze the captured image, and carry out search on the communication network (Internet) while using the character string or image part contained in the image as a search target, thereby detecting the output source of the image. As a result, only by capturing the image of the Web page being displayed by the another information output apparatus 2, the PC apparatus 1 not only can connect to the Internet and display the image, but also can search the Web page even if the Web page being displayed by the another information output apparatus 2 does not contain a URL. Accordingly, reliability and user-friendliness are improved.

The PC apparatus 1 is configured to: capture an image of the Web page being displayed by the another information output apparatus 2; if a plurality of output sources are detected as options as a result of analyzing the captured image and carrying out search on the communication network while using the character string or image part contained in the image as a search target, sequentially judge whether the Web pages obtained by sequentially accessing the output sources of the options and the Web page being outputted by the another information output apparatus 2 are identical to each other or not; and, if they are identical Web pages, determine the option as the output source and acquire a Web page from the determined output source and output it. Accordingly, detection of the output source can be more reliably carried out.

The PC apparatus 1 is configured to: capture an image of the Web page being displayed by the another information output apparatus 2; if a plurality of output sources are detected as options as a result of analyzing the captured image and carrying out search on the communication network while using the character string or image part contained in the image as a search target, sequentially judge whether the Web pages obtained by sequentially accessing the output sources of the options and the Web page being outputted by the another information output apparatus 2 are identical to each other or not; and, if an identical Web page cannot be searched, display a guide message of the fact. Therefore, the user can be informed of the fact that the corresponding Web page cannot be searched, and the user can immediately take a measure.

The PC apparatus 1 is configured to capture an image of the Web page being displayed by the another information output apparatus 2: and, when the PC apparatus 1 analyzes the captured image and uses the character string or image part contained in the image as a search target, specify a search target by analyzing the screen configuration displaying the Web page. Accordingly, the search target can be specified based on, for example, a window title(S), a tab title(s), a site banner(s), site navigation, contents navigation, main contents, an advertisement(s), etc.

If a location (URL) on the network is not contained as a result of analyzing the captured image of the Web page being displayed by the another information output apparatus 2, the PC apparatus 1 is configured to carry out search on the communication network while using the character string or image part contained in the Web page, thereby detecting the output source of the image. Accordingly, search on the communication network can be carried out while using the character string or image part as a search target on the condition that no URL is contained, and detection of the output source can be more reliably carried out.

In the case where a plurality of output sources are detected as options as a result of carrying out the search on the communication network while using the character string or image part as the search target, if the number of the options is equal to or more than the predetermined value, the PC apparatus 1 is configured to change the search target and then carry out search again on the communication network based on the changed search target. Accordingly, detection of the output source can be more reliably carried out.

In the above-described third embodiment, the case where the search on the Internet is carried out based on the detected output source is exemplified. However, search on a LAN (Local Area Network) may be configured to be carried out.

In the above-described third embodiment, if a plurality of output sources are detected as options, the PC apparatus 1 is configured to sequentially judge whether the Web pages obtained by sequentially accessing the output sources of the options and the Web page being outputted by the another information output apparatus 2 are identical to each other or not and, if it is judged to be the identical Web page, determine the option as the output source. However, if a plurality of output sources are detected as options, the output source may be configured to be determined by user selection without carrying out automatic determination as described above.

More specifically, in a state where the options are displayed by a list, search on the communication network may be carried out based on an option selected therefrom by user operation. When the options are displayed, sites (news, EC (Electronic Commerce), summary sites, corporate sites, blogs, etc.), categories of contents (board category top, blog contents top, EC-site category top) may be configured to be displayed.

In the first to third embodiments, when control for outputting the information identical to the information being outputted to the another information output apparatus 2 is carried out, the PC apparatus 1 is configured to display the information in itself. However, the PC apparatus 1 may carry out control to transmit the information to another apparatus (for example, a portable terminal apparatus or television receiver), thereby displaying the information in the other apparatus side.

The first to third embodiments show the case of application to the desktop PC apparatus 1 as an information output apparatus. However, the apparatus may be a television receiver or an electronic game device provided with an Internet connection function, a portable phone such as a smartphone, a tablet terminal apparatus, a portable information communication device, etc. The another information output apparatus 2 is not limited to a portable terminal apparatus or a laptop PC, but may be a desktop PC apparatus, a television receiver, a radio receiver, etc.

The each of “apparatuses” and “sections” shown in the above-described first to third embodiments may be separated by functions into a plurality of chassis and are not limited to be in a single chassis. The steps described in the above-described flowcharts are not limited to temporal processing, and the plurality of steps may be processed in parallel or may be separately independently processed.

While the present invention has been described with reference to the preferred embodiments, it is intended that the invention be not limited by any of the details of the description therein but includes all the embodiments which fall within the scope of the appended claims.

What is claimed is:

1. An information output apparatus for outputting information, comprising:
an acquisition section which acquires information being displayed by another information output apparatus other than the information output apparatus;
a detection section which analyzes the information acquired by the acquisition section and detects an output source of the information; and
an output control section which carries out control for accessing the output source detected by the detection section, and outputting information identical to the information, which is being outputted by the another information output apparatus.

2. The information output apparatus according to claim 1, further comprising an imaging section which captures an image,
wherein the acquisition section acquires the captured image when an image being displayed by the another information output apparatus is captured by the imaging section, and
wherein the detection section analyzes the captured image acquired by the acquisition section and detects an output source of the image.

3. The information output apparatus according to claim 2,
wherein the captured image acquired by the acquisition section is an image capturing an image on a communication network being displayed by the another information output apparatus, and
wherein the detection section detects, as the output source of the image, a location on the network subsequent to a specific unique noun in a character string contained in the image on the network acquired by the acquisition section.

4. The information output apparatus according to claim 2,
wherein the captured image acquired by the acquisition section is an image capturing a television broadcast image being displayed by the another information output apparatus, and
wherein the detection section detects a channel containing a similar image as the output source of the image by scanning each channel of television broadcast while using the television broadcast image acquired by the acquisition section as a key.

5. The information output apparatus according to claim 2,
wherein the captured image acquired by the acquisition section is an image capturing an application screen being displayed upon application processing in the another information output apparatus, and
wherein the detection section detects, as the output source of the image, a type of the application judged from contents of a header portion in the application image acquired by the acquisition section.

6. The information output apparatus according to claim 2
wherein the captured image acquired by the acquisition section is an image capturing a material screen being displayed by the another information output apparatus, and
wherein the detection section detects, as the output source of the image, specifying information specifying a material file thereof or specifying information specifying a page in the material file according to contents of a header portion or a footer portion in the material screen acquired by the acquisition section.

7. The information output apparatus according to claim 2,
wherein the detection section analyzes the captured image acquired by the acquisition section, judges a type of an image capture target thereof, and then detects the output source of the image in accordance with the type.

8. The information output apparatus according to claim 7,
wherein the detection section analyzes the captured image acquired by the acquisition section and judges the type of the image capture target based on at least any one of: whether the captured image has a portion therein, including a header portion or a footer portion, which meets a predetermined form; whether the captured image contains a predetermined character or number in the portion of the captured image that meets the predetermined form; whether the captured image contains a predetermined referential index; and whether the captured image is a still image or a moving image.

9. The information output apparatus according to claim 1, further comprising a sound collecting section which collects a sound,
wherein the acquisition section acquires the sound as the information when the sound being outputted by the another information output apparatus is collected by the sound collecting section, and
the detecting section analyzes the sound acquired by the acquisition section and detects an output source of the sound.

10. The information output apparatus according to claim 9,
wherein the detection section scans each station while using the sound acquired by the acquisition section as a key, thereby detecting the station containing a similar sound to the sound acquired by the acquisition section as the output source of the sound.

11. The information output apparatus according to claim 9, further comprising a specifying section which arbitrarily inputs and specifies a type of the information, which has been acquired by the acquisition section, by user operation,
wherein the detection section detects the output source of the information in accordance with the type of the information specified by the specifying section.

12. The information output apparatus according to claim 1,
wherein the output control section judges whether the information acquired by accessing the output source and the information acquired by the acquisition section is identical to each other or not,
wherein, if the information is not identical to each other, the output control section carries out control for repeatedly executing an operation of detecting the output source of the information by further re-operating the acquisition section and the detection section, and
wherein, if the information is identical to each other, the output control section carries out control for outputting information from the output source.

13. The information output apparatus according to claim 1,
wherein the detection section detects a plurality of output sources as options based on an analysis result of analyzing the information acquired by the acquisition section,
wherein the output section sequentially judges whether information obtained by sequentially accessing the output sources detected as the options by the detection section and the information acquired by the acquisition section is identical to each other or not, and
wherein, if the information is judged to be identical to each other, the output section determines the option as the output source, acquires information from the determined output source, and outputs the information.

14. The information output apparatus according to claim 1, further comprising an imaging section which captures an image on a communication network being displayed by the another information output apparatus,
wherein the acquisition section acquires the captured image captured by the imaging section, and
wherein the detection section analyzes the captured image acquired by the acquisition section and carries out search on the communication network while using a character string or an image part contained in the image as a search target, thereby detecting an output source of the image.

15. The information output apparatus according to claim 14,
wherein the detection section carries out search on the communication network while using the character string or the image part as the search target and, as a result, detects a plurality of output sources as options, and
wherein the output section sequentially judges whether the information obtained by sequentially accessing the output sources detected as the options by the detection section and the information acquired by the acquisition section is identical to each other or not, and
wherein, if the information is judged to be identical to each other, the output section determines the option as the output source, acquires information from the determined output source, and outputs the information.

16. The information output apparatus according to claim 15,
wherein the output section sequentially judges whether the information obtained by sequentially accessing the output sources detected as the options by the detection section and the information acquired by the acquisition section is identical to each other or not, and
wherein, if the information is judged to be not identical to each other, the output section outputs guide information of the judgment.

17. The information output apparatus according to claim 14,
wherein, when the captured image acquired by the acquisition section is analyzed and a character string or an image part contained in the image is used as a search target, the search target is specified by analyzing a screen configuration displaying the image.

18. The information output apparatus according to claim 14,
wherein, when a location on a network subsequent to a specific unique noun in the character string contained in the image on the network acquired by the acquisition section cannot be detected as the output source of the image, the detection section carries out search on the communication network while using the character string or the image part contained in the image as the search target, thereby detecting the output source of the image.

19. The information output apparatus according to claim 14,
wherein, when the detection section detects a plurality of output sources as options as a result of carrying out search on the communication network while using the character string or the image part as the search target, if number of the options is equal to or more than a predetermined value, the detection section changes the search target and then carries out search again on the communication network based on the changed search target.

20. An method of an information output apparatus for outputting information, comprising:
an acquisition step of acquiring information being displayed by another information output apparatus other than the information output apparatus:
a detection step of analyzing the information acquired by the acquisition step and detecting an output source of the information; and
an output control step of carrying out control for accessing the output source detected in the detection step and outputting information identical to the information being outputted by the another information output apparatus.
